(19) United States
(12) Patent Application Publication
(10) Pub. No.: US 2014/0001071 A1
(43) Pub. Date: Jan. 2, 2014

(54) PACKAGE FOR LAUNDRY DETERGENT HAVING APPARENT PRE-TREAT CAPABILITY

(71) Applicants: Michael David Sanders, Cincinnati, OH (US); Ebony Nicole Sanders, Cincinnati, OH (US)

(72) Inventors: Michael David Sanders, Cincinnati, OH (US); Ebony Nicole Sanders, Cincinnati, OH (US)

(21) Appl. No.: 13/537,896

(22) Filed: Jun. 29, 2012

(51) Int. Cl. B65D 85/00; B67D 3/00

(52) U.S. Cl. 206/459.5; 222/111

(57) ABSTRACT

A laundry detergent package having a dosing cap having surface irregularities on the base exterior surface of the dosing cap, the surface irregularities visible to an observer of the laundry detergent package when the primary label face is viewed by an observer having a line of sight level with the base exterior surface.

### FIELD OF THE INVENTION

A package for laundry detergent having apparent pre-treat capability.

### BACKGROUND OF THE INVENTION

Dosing caps having a scrubbing element designed to be used as a device for pre-treating stains can be provided as a closure or an attached dosing cap for a package for laundry detergent. The scrubbing element can be provided on a part of the dosing cap that is disposed on the interior of the package when the package is in a closed position. For instance, the scrubbing element might be disposed on or proximal to the rim of the dosing cap such that when the dosing cap is snapped to a container or screwed into an opening in the container that contains laundry detergent, the scrubbing element is protected within the container during transport, display, and between uses of the product. One drawback of configuring the dosing cap in such a manner is that the scrubbing element is obscured from the view of a purchaser when she is selecting the product from the shelf at the retailer. Such an arrangement may not be most desirable to a marketer of a laundry detergent because the consumer may not be aware of the pre-treat benefit that is provided with the cap because the scrubbing element is obscured within the package.

To improve on the ability for a consumer to recognize that a pre-treat benefit is provided by the dosing cap, designers may choose to locate the scrubbing element on the exterior of the dosing cap so that the scrubbing element might be more visible to the consumer at the point of selection. Although such a choice may be helpful to a consumer inspecting the laundry detergent package when she is holding the package or when the package is displayed on a table, just locating the scrubbing element on the exterior of the dosing cap may not be enough to provide for adequate visibility of the scrubbing element at the point of selection.

Laundry detergents are commonly displayed on shelves having an open height that is only slightly greater than the height of the package. Retailers arrange their shelves as such to maximize the amount of product that can be presented to the consumer at a height ranging from the floor to about 2.5 m, which can provide the greatest amount of inventory per square meter of floor space and be within a conveniently viewable range. Thus, the base of the dosing cap, which is the top of the package, and part of the peripheral wall of the dosing cap are in many instances obscured from view of the consumer unless she removes the package from the shelf.

With these limitations in mind, when an exciting technology, such as a scrubbing element provided as an integral part of the cap or dosing cap, is added to the external part of the packaging for a laundry detergent, there is a need and desire to make sure that the exciting feature is in view of a purchaser when she is choosing which product to purchase at the shelf at the retailer. This may be especially true on account that the technology for laundry detergents is often molecularly driven and is not visibly cognizable to the consumer and marketers may be eager for any opportunity to directly show the potential consumer some aspect of the technology provided with their product.

### SUMMARY OF THE INVENTION

A laundry detergent package comprising: a container having a container interior surface and an opposing container exterior surface, wherein the container exterior surface has a primary label face; and a dosing cap comprising a base and a vessel wall extending from the base, the base having a base interior surface and an opposing base exterior surface, the vessel wall having a vessel wall interior surface and an opposing vessel wall exterior surface, wherein the base exterior surface comprises a region of surface irregularities; wherein the dosing cap is releasably engaged with the container; wherein the region of surface irregularities is positioned such that when the primary label face is aligned with a line of sight of an observer having her eye level with the base exterior surface the region of surface irregularities is visible to the observer.

A plurality laundry packages. Each laundry package comprising: a container having a container interior surface and an opposing container exterior surface, wherein the container exterior surface has a primary label face; and a dosing cap comprising a base and a vessel wall extending from the base, the base having a base interior surface and an opposing base exterior surface, the vessel wall having a vessel wall interior surface and an opposing vessel wall exterior surface, wherein the base exterior surface comprises a region of surface irregularities; wherein the dosing cap is releasably engaged with the container; wherein the region of surface irregularities is positioned such that when the primary label face is aligned with a line of sight of an observer having her eye level with the base exterior surface the region of surface irregularities is visible to the observer, wherein each dosing cap has a longitudinal axis and the plurality of laundry packages is arranged such that the longitudinal axis of each respective dosing cap is substantially aligned within a common line of alignment.

### BRIEF DESCRIPTION OF THE DRAWINGS

FIG. 1 is a laundry detergent package as viewed by an observer on a shelf in a retailer.

FIG. 2 is a drawing of an observer viewing a laundry detergent package on a shelf in a retailer.

FIG. 3 is top view of a laundry detergent package illustrating the position of an observer's eye relative to the laundry detergent package.

FIG. 4 is a drawing of a plurality of laundry detergent packages arranged on a shelf.

FIG. 5 is a schematic illustrating ribs.

FIG. 6 is a schematic illustrating nubs.

FIG. 7 is a schematic illustrating bristles.

FIG. 8 is a schematic illustrating rings.

FIG. 9 is a schematic of a perspective view of a dosing cap.

### DETAILED DESCRIPTION OF THE INVENTION

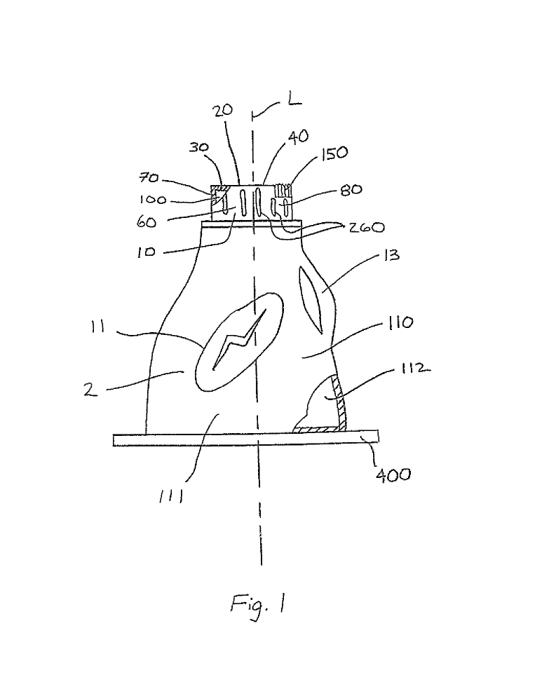

FIG. 1 illustrates an embodiment of a laundry detergent package 1 on a shelf 400. In general, the laundry detergent package 1 can be of the general type for the laundry detergent distributed under the brand TIDE by The Proctor & Gamble Co., Cincinnati, Ohio, USA, as of Jun. 29, 2012. The laundry detergent can be a liquid or a gel.

The laundry detergent package 1 can comprise a container 110 having a container interior surface 112 and an opposing container exterior surface 111. The container 110 can be an injection molded, injection-stretch blow molded, blow molded, or other type bottle made of high density polyethylene, polypropylene, or other suitable material. The container 110 can have a handle 13 integral with or extending from the container 110, the handle 13 being sized and dimensioned to fit in a human hand and operatively engaged with the container 110. The handle 13 can be an integral part of the container 110. The handle 13 can extend from the container 110. The handle 13 can be a part that is attached to the container 110.

The exterior surface 111 can have a primary label face 2. The primary label face 2 is the part of the container exterior surface 111 that is presented to the consumer when the product is on a shelf in a store. The primary label face 2 is the front of the package. The primary label face 2 includes the name of the product. The primary label face 2 may include other information such as use for the product, advertising claims, net weight or volume of the contents of the laundry detergent package 1. The primary label face 2 may include graphics intended to connote an expected benefit such as a scent or vivid white laundry. The primary label face 2 may include information on the contents of the formulation of the laundry detergent such as whether any one of or combination of technologies such as bleach, enzymes, brighteners, fabric softener, and wrinkle reducer are provided in the formulation. The exterior surface 111 may have a secondary label face that is not entirely presented to the consumer when the product is displayed on a shelf. The secondary label face may be the back of the packaging. The secondary label face can oppose the primary label face 2. The secondary label face may include information such as the name of the product, the manufacturer or distributor, an ingredient list, instructions for use, contact information for the manufacturer or distributor, and UPC coding for the laundry detergent package 1. The primary label face 2 can be free from an optically scanable product code, such as a universal product code, bar code, AT&T uverse coupon code, or other such 2-D product code readable by an optical check-out scanner at a retailer. In one embodiment, the container 110 can have a brand logo 11. The brand logo 11 on the label face 2 can be larger than any other appearance of the brand logo 11 on another portion of the container 110. The brand logo 11 can be text and/or indicia.

The laundry detergent package 1 can comprise a dosing cap 10. The dosing cap 10 can comprise a base 20. The base 20 has a base interior surface 30 and a base exterior surface 40 opposing the base interior surface 30. The base 20 can be a single layer of material, such as high density polyethylene, a multilayered material, a hollow member, or any other such structure or material having sufficient structural integrity to be used in a dosing cap 10 for a container 110 of laundry detergent. The base exterior 40 can provide a surface arrangement that can be stably set upon another surface that is substantially flat as measured on a scale of whole centimeters, such as a table or a flat portion of a washing machine or dryer. Such surface arrangement can be a generally flat surface or contoured surface arrangement. When the base 20 is set on a flat surface, laundry detergent from a container 110 can be poured into the pour volume 100 of the dosing cap 10 and the dosing cap 10 may not easily tip over as laundry detergent is poured or squirted into the dosing cap 10.

A vessel wall 60 extends from the base 20. The vessel wall 60 extends about the longitudinal axis L of the cap. The vessel wall 60 has a vessel wall interior surface 70 and a vessel wall exterior surface 80 opposing the vessel wall interior surface 70. The vessel wall 60 can be a single layer of material, such as high density polyethylene, a multilayered material, a hollow member, or any other such structure or material having sufficient structural integrity to be used as a dosing cap 10 for a container of laundry detergent. The vessel wall interior surface 70 can be provided with one or more indicia that mark the desired level of laundry detergent composition that provides for an appropriate unit dose of laundry detergent composition. The indicia can be an etch, a depression, a raised portion, printing, or any other structure that is observable by the consumer. The vessel wall 60 can be a cylindrical segment.

The vessel wall interior surface 70 and base interior surface 30 together define a pour volume 100, the base interior 30 forming a closed end of the pour volume 100. The pour volume can be sized and dimensioned to provide for a unit dose of the laundry detergent composition contained in the container 110. The laundry detergent composition can be a laundry detergent composition such as any of the liquid detergents marketed as TIDE, available from The Proctor & Gamble Co., Cincinnati, Ohio, USA, as of Jun. 29, 2012. In one embodiment, the vessel wall interior surface 70 and base interior surface 30 can together form an open ended, or partially open ended, cup with the base interior surface 30 forming the closed end of the dosing cap 10. The dosing cap 10 can have a longitudinal axis L that extends through the open portion of the open end of the dosing cap 10 defined by or partially defined by the rim of the vessel wall 60.

The vessel wall interior surface 70 of the vessel wall 60 can be defined by a surface of revolution about the longitudinal axis L. In one embodiment, vessel wall interior surface 70 of the vessel wall 60 can be defined by a portion of the interior surface of a hollow cylinder. Surfaces of revolutions of functions not parallel to the longitudinal axis L and surfaces of revolution of non-linear functions are contemplated. A dosing cap 10 having a vessel wall interior surface 70 of vessel wall 60 that is a surface of revolution can provide for ease of manufacture of the dosing cap 10 and engaging the dosing cap 10 with the container 110 after filling the container 110 with laundry detergent composition during manufacture and packaging.

The dosing cap 10 can be engaged with the container 110. For example, the dosing cap 10 can be engaged with a closure to the container. The closure can be, for example, a flip top closure or pull opened nozzle or a threaded closure. Engagement between the dosing cap 10 and the closure can be provided by, for example, a threaded connection or a compression fit. The dosing cap 10 can be releasably engaged with an opening in the container 110 containing a laundry detergent composition. The dosing cap 10 can be releasably engaged to the container 110, for instance, by interlocking correspondingly disposed threads on the dosing cap 10 and the container 110, a lug and groove fitting between the dosing cap 10 and the container 110. The dosing cap 10 can be releasably engaged with an opening in the container 110 such that the base interior surface 50, the vessel wall interior surface 70, and the container interior surface 112 together define an enclosure containing a laundry detergent.

To achieve the desired position of the region of surface irregularities 150 when the dosing cap 10 is engaged with the container 110, threads on the dosing cap 10, if present, and corresponding threads on the container 110, if present, can be positioned, sized, and dimensioned so that when the dosing cap 10 is engaged with the container 110, the region of surface irregularities 150 is located as desired. If a lug and groove fitting is employed between the dosing cap 10 and the container 110, then the end of the groove or grooves needs to be positioned so that when the lug abuts the end of the groove, the region of surface irregularities 150 is located as desired. The dosing cap 10 can be sealingly engaged with the container 110.

The dosing cap 10 can comprise a region of surface irregularities 150 on the base exterior surface 40. When the consumer grips the dosing cap 10 to execute pouring the laundry detergent composition, once the pour is made, the region of surface irregularities 150 can be in position to be used to scrub the stain on the fabric with the region of surface irregularities 150 without requiring the consumer to reposition the cap in her hand. If the laundry detergent composition is not pourable, for instance the liquid laundry composition is a gel, the consumer can using the region of surface irregularities 150 on the dosing cap 10 to scrub a stain while still reserving a volume of laundry detergent in the dosing cap 10. When finished pretreating the stain, the consumer can toss the dosing cap 10 with the reserve laundry detergent into the washing machine.

The region of surface irregularities 150 can provide a topographically diverse surface that can be rubbed against a stained fabric before or after laundry detergent composition is applied to a stain in a fabric as part of a stain pretreatment process. A topographically diverse surface is a surface that is not smooth. The region of surface irregularities 150 when rubbed against a stain on a fabric is thought to help dislodge agglomerations of the stain, gently deform the fibrous structure of the fabric allowing the laundry detergent composition to more completely penetrate the fibrous structure, and manipulate the fibers of the fabric thereby allowing a greater surface area of the fibers to be wetted with the laundry detergent composition. Without being bound by theory, it is believed that dislodging agglomerations of the stain, more completely penetrating the stained fabric with the laundry detergent composition, and applying the laundry detergent composition to a greater surface area of fibers can improve the efficacy of pre-treatment of stains in fabrics.

The vessel wall exterior surface 80 can comprise a plurality of gripping irregularities 260. The gripping irregularities 260 can be selected from the group consisting of depressed portions relative to the vessel wall 60, raised portions relative to the vessel wall 60, and combinations thereof. The gripping irregularities 260 can provide for a roughened surface of the vessel wall exterior surface 80 that allows the consumer to have a sturdy grip on the dosing cap 10 when she removes the dosing cap 10 from the container 110 and uses the dosing cap 10 to dispense a unit dose of laundry detergent.

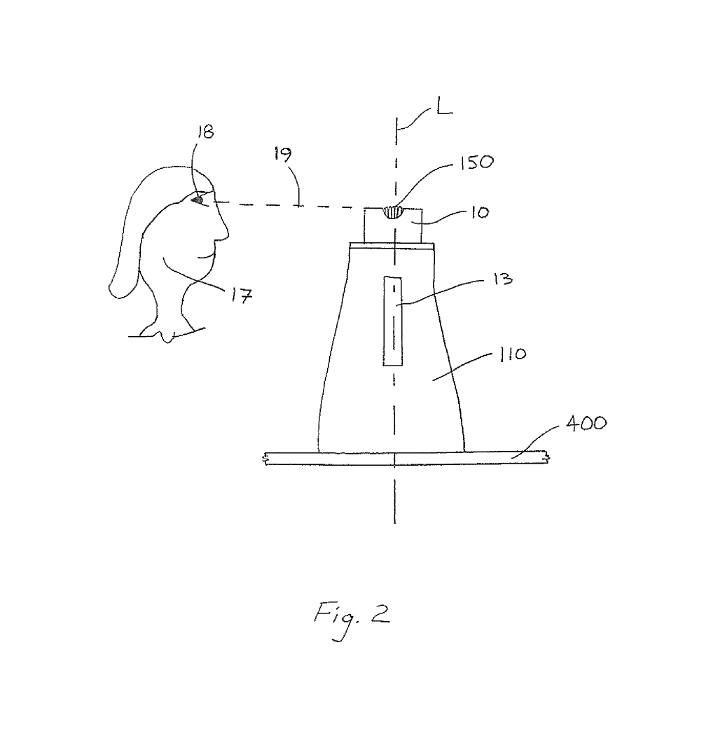

In one embodiment, the region of surface irregularities 150 is positioned such that when the primary label face 2 is aligned with a line of sight of an observer 17 having her eye 18 level with the base exterior surface 40, the region of surface irregularities 150 is visible to the observer 17, as shown schematically in FIG. 2. The observer 17 can be a person shopping for laundry detergent viewing the laundry detergent package 1 on a shelf 400. Laundry detergent packages 1 are commonly presented to the consumer on crowded shelves having an open height only slightly greater than the height of the laundry detergent package 2. As such, there are two general ranges of positions for the region of surface irregularities 150 when the primary label face 2 is aligned with a line of sight of an observer 17 having her eye 18 level with the base exterior surface 40. One general range of positions is the range of positions such that at least a portion of the region of surface irregularities 150 is generally oriented on the same side of the laundry detergent package 1 as the primary label face 2. The second general range of positions is the range of positions such that at least a portion of the region of surface irregularities 150 is generally oriented on the side of the laundry detergent package 1 opposite the primary label face 2.

An embodiment in which the region of surface irregularities 150 is positioned such that when the primary label face 2 is aligned with a line of sight of an observer 17 having her eye 18 level with the base exterior surface 40, the region of surface irregularities 150 is visible to the observer 17 can be practical because such an arrangement allows the consumer to see that the laundry detergent package 1 is provided with the exciting feature of a dosing cap 10 that is capable of being used to pre-treat stained garments, without removing the laundry detergent package 1 from the shelf to inspect the package 1 more closely. Such a benefit can be provided when, for example, the laundry detergent package 1 is placed on a shelf at a height ranging from just above the floor to about 2.5 m high.

The preceding arrangement is in contrast to general range of positions for the region of surface irregularities 150 in which the region of surface irregularities 150 is generally oriented on the side of the laundry detergent package 1 opposite the primary label face 2. When the consumer views such a laundry detergent package 1 in the store, she will not be able to see that the laundry detergent package 1 is provided with the exciting feature of a dosing cap 10 that can be used to pre-treat stained garments. The inability for the consumer to recognize the benefit is problem for marketers because a clear channel for communicating with the consumer is to show the features of the product at the point of product selection. If the surface irregularities 150 are not presented to the observer 17 at shelf, the marketer loses the opportunity to promote the pre-treat benefit at shelf. More importantly, the consumer may not become aware of the feature of a dosing cap 10 that can be used to pre-treat stained garments and she will miss out on the opportunity to achieve improved stain removal.

Of course the marketer could promote the pre-treat benefit on the label face 2 of the package 1, via an image or text, but this approach is not attractive because, as laundry detergents become more compacted and are packaged in smaller containers, label space is at a premium. Marketers tend to want to make the brand name the most predominate feature of the primary label face 2. The choice to include information on the primary label face 2 regarding the pre-treat benefit is obtained at the expense of decreasing the size of the brand name or eliminating other information that the consumer might find helpful when she selects her product.

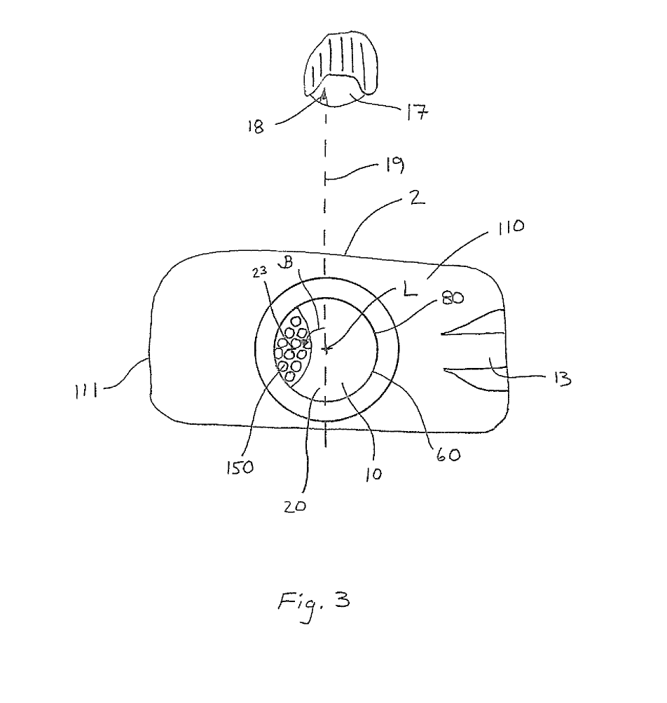

The region of surface irregularities 150 can have a centroid 23 in a plane orthogonal to the longitudinal axis L of the dosing cap 10, as shown in FIG. 3. FIG. 3 is rendered to show a top view of the head of observer 17 and indicate the position of the observer's eye 18. The centroid 23 is the center of mass of the region of surface irregularities 150 projected on a plane orthogonal to the longitudinal axis L of the dosing cap. The centroid 23 can be more than about π/8 radians away from the line of sight 19 as measured about the longitudinal axis L of the dosing cap 10. Arranged as such, it is thought that there is an increased probability that a consumer viewing the package 1 on shelf will have the opportunity to view the region of surface irregularities 150 in profile, which may make the region of surface irregularities 150 more recognizable to the consumer. If the region of surface irregularities 150 is within π/8 radians of the of the line of sight 19 as measured about the longitudinal axis L of the dosing cap 10, the region of surface irregularities 150 is presented directly to the consumer but there may not be as much contrast with the surrounding parts of the dosing cap 10 and surrounding environment as when the centroid 23 of the region of surface irregularities is presented off of the direct line of sight 19. Such an arrangement can still be desirable and practical and is advantageous over an arrangement in which the region of surface irregularities 150 is oriented away from the observer 17.

The centroid 23 can be about π/2 radians away from the line of sight 19 as measured about the longitudinal axis L of the dosing cap 10. Such an arrangement can position the region of surface irregularities 150 such that at least a portion of the region of surface irregularities 150 can be viewed by the consumer in profile. Without being bound by theory, positioning the centroid 23 of the region of surface irregularities 150 may allow the consumer to perceive the region of surface irregularities in profile which may make the region of surface irregularities 150 be visually readily perceptible to the consumer.

In one embodiment, the container 110 has a handle 13 integral with or extending from the container 110 and the handle 13 and the centroid 23 of the region of surface irregularities 150 are substantially aligned on a common side of the package 1, for example as in FIG. 1. In another embodiment, the handle 13 and the centroid 23 are on substantially opposing sides of the package 1, for example as in FIG. 3. Such arrangements might be practical because many laundry detergent packages have a handle and the handle is often positioned such that the handle appears on the left side of the package or the right side of the package when the label face is viewed by the consumer. Configuring the laundry detergent package 1 so that the centroid 23 of the region of surface irregularities 150 are substantially aligned on a common side of the package 1 or on substantially opposing sides of the package 1 can result in at least part of the region of surface irregularities 150 appearing in profile to the observer 17 and thus be more visually apparent.

A plurality of laundry detergent packages 1 can be presented to the consumer on a store on a shelf. The plurality of laundry detergent packages 1 can be presented in a side-by-side closely spaced array. The plurality of laundry detergent packages 1 can be what is referred to in the art as a shelf set. Individual laundry detergent packages 1 in a plurality of laundry detergent packages 1 can be within less than about 10 cm of one another. Individual laundry detergent packages 1 in a plurality of laundry detergent packages 1 can be within less than about 5 cm of one another. Individual laundry detergent packages 1 in a plurality of laundry detergent packages 1 can be within less than about 2 cm of one another. Individual laundry detergent packages 1 in a plurality of laundry detergent packages 1 can be within less than about 1 cm of one another. Individual laundry detergent packages 1 in a plurality of laundry detergent packages 1 can be within less than about 5 mm of one another.

Each laundry detergent package 1 can be arranged such that the longitudinal axis L of each dosing cap 10 is substantially aligned within a common line of alignment 210, as shown in FIG. 4. FIG. 4 is rendered to show a top view of the head 900 of observer 17 and indicate the position of the observer's eye 18. In this arrangement, at least part of each of the regions of surface irregularities 150 of each dosing cap 10 can be visible to the consumer. This arrangement for the dosing caps 10 can provide the consumer/observer 17 with a more satisfying experience when shopping because the common feature of the plurality of packages will be in her view. If the common feature were not within her view, she might not understand that each package is provided with the region of surface irregularities 150 and be confused in her understanding in range of packages offered. Further, the marketer of the laundry packages 1 desires that all packages appear to be identical when presented to the consumer on the shelf 400. Such uniformity can reassure the consumer that the laundry detergent package 1 and the contents therein were manufactured to exacting details.

The plurality of laundry detergent packages 1 can be configured such that each respective region of surface irregularities 150 has a centroid 23 in a plane orthogonal to a longitudinal axis L of each respective dosing cap 10, wherein each respective centroid 23 is more than about π/8 radians away from the line of sight 19 as measured about the longitudinal axis L of each respective dosing cap 10. This configuration can result in at least a portion of the region of surface irregularities 150 being viewed in profile by the consumer/observer examining the laundry detergent packages 1 on the shelf in a store. The regions of surface irregularities 150 may be more visually outstanding when viewed in profile as compared to being viewed straight on. Each centroid 23 can be positioned about zero radians away from the common line of alignment 210 to ensure that at least part of the region of surface irregularities 150 will be viewed in profile by the consumer.

In one embodiment, the region of surface irregularities 150 can comprise a first material and the vessel wall 60 can comprise a second material, wherein the first material and the second material differ from one another. Different materials can provide for different luster, which can be perceived by a consumer/observer 17 when she is examining the package 1 on the shelf. Thus, when a consumer is examining the package 1 on the shelf, she might be able to detect that the dosing cap 10 is provided with some additional exciting feature beyond just be a simple dosing cap 10 and she might be inspired to more closely examine the dosing cap 10.

In one embodiment, the region of surface irregularities 150 can comprise a first material 652 and the vessel wall 60 can comprise a second material 653, wherein the first material 652 and the second material 653 differ from one another by a property selected from the group consisting of modulus of elasticity, chemical composition, Shore A hardness, color, and combinations thereof. Shore A Hardness is measured following ASTM D2240 on a material of the same composition as the material being evaluated. A dosing cap 10 comprising a region of surface irregularities 150 comprised of a first material 652 and a vessel wall 60 comprising a second material 653 can be formed by a two shot injection molding process, with the first material 652 and the second material 653 delivered to the mold in separate shots of resin. In one embodiment, the first material 652 can comprise polypropylene, rubber, neoprene, and/or KRATON. In one embodiment, the portion of the dosing cap 10 next to the first material 652 can be high density polyethylene, polypropylene, polyamide, styro lacrylintrol. The region of surface irregularities 150 can comprise an elastomeric material.

In one embodiment, the first material 652 can have a softer feel to the user than the second material 653, as might be indicated by a lower Shore A hardness or lower modulus of elasticity. The second material 653 can be selected to provide for acceptable overall structural stability of the dosing cap 10 during packaging, storing, shipping, and display of the laundry detergent composition and during use of the dosing cap 10 by the consumer to pre-treat stains. A more readily deformable first material 652 might provide for scrubbing surface that is gentler on the fabric being treated than a scrubbing surface formed of the second material 653 and may not damage the fabric being treated. The first material 652 can have a Shore A hardness between about 20 and about 80. The first material 652 can have a Shore A hardness of between about 40 and about 60. The first material 652 can have a Shore A hardness that is less than about 80% of the Shore A hardness of a portion of the dosing cap 10 next to the first material 652.

In one embodiment, the region of surface irregularities 150 can comprise a first material 652 and the vessel wall 60 can comprise a second material 653, wherein the first material 652 and the second material 653 are measured by a Hunter Reflectance Meter test according to the colors L*, a*, and b*, the L*, a*, and b*, wherein the first material 652 has a color difference, the color difference being calculated using the L*, a*, and b* values by the formula ΔE=[(L*_{X}*−L*_{Y})²+(a*_{X}*−a*_{Y})²+(b*_{X}−b*_{Y})²]^{1/2}, wherein the ΔE between the first material 652 and the second material 653 is at least about 1.

The color of the first material 652 and second material 653 are measured by the reflectance spectrophotometer according to the colors L*, a*, and b* values.

The color difference is calculated using the L*, a*, and b* values by the formula ΔE=[(L*_{X}*−L*_{Y})²+(a*_{X}*−a*_{Y})²+(b*_{X}—b*_{Y})²]^{1/2}. Herein, the ‘X’ in the equation represents the first material 652 and ‘Y’ represents the second material 653, X and Y cannot be the same two points of measurement at the same time. For any particular comparison of the difference in color, the location of X≠the location of Y.

Reflectance color is measured using the Hunter Lab LabScan XE reflectance spectrophotometer obtained from Hunter Associates Laboratory of Reston, Va. A dosing cap 10 is tested at an ambient temperature between 18° C. and 24° C. and a relative humidity between 50% and 80%.

The spectrophotometer is set to the CIELab color scale and with a D65 illumination. The Observer is set at 10° and the Mode is set at 45/0°. Area View is set to 0.125″ and Port Size is set to 0.20″. The spectrophotometer is calibrated prior to sample analysis utilizing the black glass and white reference tiles supplied from the vendor with the instrument. Calibration is done according to the manufacturer's instructions as set forth in LabScan XE User's Manual, Manual Version 1.1, August 2001, A60-1010-862. If cleaning is required of the reference tiles or samples, only tissues that do not contain embossing, lotion, or brighteners should be used (e.g., PUFFS tissue). Any sample point on the cap containing the color to be analyzed can be selected.

The dosing cap 10 is placed over the sample port of the spectrophotometer with a white clamp disk placed behind the dosing cap 10.

The dosing cap 10 is removed and repositioned so that a minimum of six readings of color of the dosing cap 10 are conducted. If possible (e.g., the size of the imparted color on the element in question does not limit the ability to have six discretely different, non-overlapping sample points), each of the readings is to be performed at a substantially different region on the externally visible surface so that no two sample points overlap. If the size of the portion of the cap comprising the first material 652 or second material 653 requires overlapping of sample points, only six samples should be taken with the sample points selected to minimize overlap between any two sample points. The readings are averaged to yield the reported L*, a*, and b* values for a specified color on an externally visible surface of an element. The first material 652 and second material 653 are considered to have different colors if ΔE is greater than about 1. Providing the first material 652 and the second material 653 in two different colors can help the consumer quickly recognize that there is an exciting feature on the dosing cap 10 that is engineered to be used for scrubbing the stain and might be helpful to vision systems that might be used to position the dosing cap 10 during manufacture and/or assembly of the dosing cap 10 and package 1 of the laundry detergent composition.

The region of surface irregularities 150 can have a surface topography that is distinct from the surface topography of portions of the dosing cap 10 adjacent the region of surface irregularities 150. The region of surface irregularities 150 can provide for a surface having a plurality of peaks and a plurality of low portions that have an amplitude between adjacent peaks and low portions greater than about 0.1 mm. The region of surface irregularities 150 can provide for a surface having a plurality of peaks and a plurality of low portions that have an amplitude between adjacent peaks and low portions greater than about 0.2 mm. The region of surface irregularities 150 can provide for a surface having a plurality of peaks and a plurality of low portions that have an amplitude between adjacent peaks and low portions greater than about 0.5 mm. The region of surface irregularities 150 can provide for a surface having a plurality of peaks and a plurality of low portions that have an amplitude between adjacent peaks and low portions greater than about 1 mm. The low portions can be valleys. The region of surface irregularities 150 can define a region that has a surface topography that differs from the surface topography of portions of the dosing cap 10 adjacent the region of surface irregularities 150. The region of surface irregularities 150 can be a series of elevated portions having intermittently disposed recessed portions. Recessed portions can be continuous. Elevated portions can be continuous.

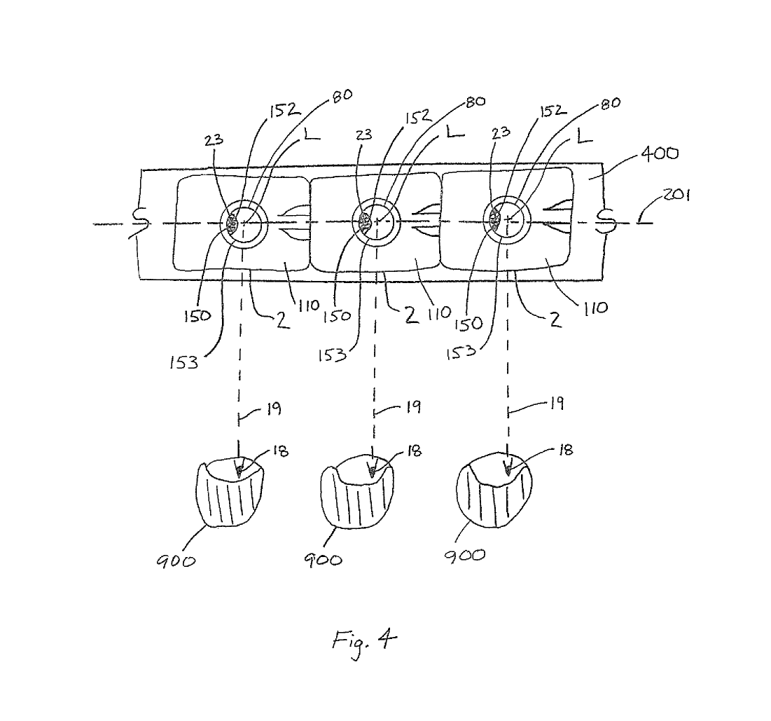

The region of surface irregularities 150 can be structures selected from the group consisting of rings, ribs, nubs, bristles, fibers, and combinations thereof. Ribs 152 are a plurality of elongated elevated portions with intermittently disposed elongated recessed portions that are depressed relative to the elevated portions, a non-limiting example of which is shown in FIG. 5. Ribs 152 can be, for example, a plurality of adjacent grooves etched or molded in substrate and can be a plurality of adjacent ridges. Ribs 152 can be formed in a substrate, for example, by etching a plurality of adjacent grooves in the substrate, by molding the substrate to leave behind a plurality of adjacent grooves, and by molding the substrate to leave behind a plurality of adjacent ridges. Ribs 152 can have any desired cross sectional shape including straight edged and rounded. Ribs 152 can be curved along their length. Ribs 152 are thought to provide for a bumpy topography that can effectively scrub and massage the fabric.

Nubs 154 are generally two-dimensionally symmetric features that are elevated or depressed relative to adjacent portions, an example schematic of which is shown in FIG. 6. Nubs 154 can be, by way of non-limiting examples, elevated portions or depressed portions having a shape of a portion of a hemisphere and elevated portions or depressed portions having a shape of a cylinder having a height H less than half the diameter D. An example of a substrate that can form a portion of dosing cap 10 having a region of surface irregularities 150 having nubs 154 is schematically illustrated in FIG. 6. Nubs 154 are thought to provide for a bumpy topography that can effectively scrub and massage the fabric.

An example of a portion of dosing cap 10 having a plurality of bristles 156 is schematically illustrated in FIG. 7. Bristles 156 are filaments having an aspect ratio of height H to diameter D greater than about 0.5. The diameter D is determined at the base of the bristle which is the location from which the bristle 156 extends from the dosing cap 10. The height H of the bristle 156 is measured orthogonal to the surface from which the base of the bristle 156 extends with the bristle 156 extended orthogonally from the surface from which the base of the bristle 156 extends. Bristles 156 can have a self sustaining shape when extended from the surface from which the base of the bristle 156 extends. For bristles 156 having a non-cylindrical cross section, the diameter D is taken to be the diameter of a cylinder having the same cross-sectional area as the cross-section area of the bristle 156 at the location from which the bristle 156 extends from the dosing cap 10. The filaments can be discrete filaments. Bristles 156 can be filaments having an aspect ratio of height H to diameter D greater than about 1. Bristles 156 can be filaments having an aspect ratio of height H to diameter D greater than about 0.5. Bristles 156 can be generally columnar bristles 156. Bristles 156 are thought to provide for a rough texture/topography that can effectively scrub and massage the fabric. Bristles 156 can be hollow. Bristles 156 can have a fixed end 256 and a free end 257. Bristles 156 can have a height from about 1 mm to about 10 mm. Bristles 156 can have a height from about 3 mm to about 7 mm. Bristles 156 can have a height less than about 7 mm.

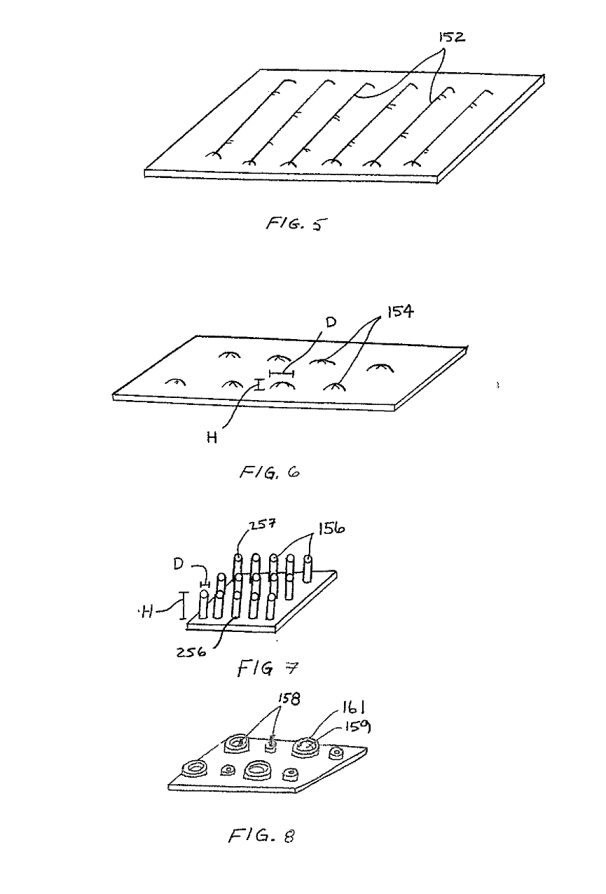

Rings 158 are closed shapes in which the central portion 159 of the shape is recessed relative to a peripheral portion 161 of the shape, schematic examples of which are shown in FIG. 8. Rings 158 are thought to be practical in that they provide for a bumpy topography that can effectively scrub and massage the fabric. Rings can have a height between about 0.5 mm to about 3 mm. Rings can have a height less than about 2 mm. Rings can have a height of about 1.5 mm.

Fibers can be woven, nonwoven, hooked, or looped fibers, for example, and be provided for instance by a woven or nonwoven fibrous web being attached to the dosing cap 10 in the desired location. An inexpensive and easily manufactured embodiment of dosing cap 10 can be made by using fibers as the surface irregularities 150.

For a region of surface irregularities 150 comprising bristles 156, bristles 156 can be formed such that the bristles are generally aligned parallel to the longitudinal axis L of the dosing cap 10 or generally aligned orthogonal to the longitudinal axis L of the cap, or at some other angle relative to the longitudinal axis L. In such an arrangement, when the region of surface irregularities 155 is scrubbed against the stained fabric, the dosing cap 10 is likely to be tilted. Thus, as the user scrubs with the dosing cap 10, a combination of normal forces and shear forces can be delivered to the stained fabric and the bristles 156 may tend to bend thereby creating an effective brushing movement of the individual bristles 156.

The bristles 156, if present in the region of surface irregularities 150, can be set such that the bristles 156 are nested with the maximum radial extent of the vessel wall exterior surface 80 of the dosing cap 10 from the longitudinal axis L. Such an arrangement can protect the bristles 156 from damage during transport, storage, and use. For a similar benefit, the bristles 156 can be set such that the bristles 156 are nested within the maximum axial extent along the longitudinal axis L of the dosing cap 10.

For high density liquid detergent compositions, the pour volume 100 can be sized and dimensioned to provide for a pour volume 100 that is between about 10 mL and about 200 mL. Depending on the compactness of the high density liquid detergent composition, the pour volume 100 can be sized and dimensioned to provide for a pour volume 100 that is between about 30 mL and about 100 mL. Depending on the compactness of the high density liquid detergent composition, the pour volume 100 can be sized and dimensioned to provide for a pour volume 100 that is between about 45 mL and about 77 mL. The vessel wall 60 can define a radial perimeter about the longitudinal axis L of about 225 mm. The vessel wall 60 can have a height of about 67 mm.

The region of surface irregularities 150 can comprise a thermoplastic elastomer. Employing a thermoplastic elastomer for the region of surface irregularities 150 can be advantageous because thermoplastic elastomers may be gentler on fabrics when rubbed against a fabric being treated, as opposed to thermoset material. The region of surface irregularities 150 can be acrylonitrile butadiene styrene. The vessel wall 60 and/or the base 20 may be comprised of a thermoset material in the embodiments described herein. The vessel wall 60 and/or base 20 may be comprised of acrylonitrile butadiene styrene. The vessel wall 60 and/or base 20 may be comprised of polypropylene. The vessel wall 60 and/or base 20 can be comprised of the material used in caps of packaging of TIDE liquid detergent, manufactured by The Proctor & Gamble Co., Cincinnati, Ohio, as of Mar. 22, 2012. If the vessel wall 60 and/or base 20 is polypropylene and a thermoplastic elastomer is used for either or both of the region of surface irregularities 150, the thermoplastic elastomer can be selected such that it is of the type that is compatible with polypropylene.

It can be practical to a have a dosing cap 10 wherein the region of surface irregularities 150 and the vessel wall 60 comprise materials having different chemical compositions from one another so as to provide different benefits with different portions of the dosing cap 10 and/or to cost-optimize manufacture of the dosing cap 10.

The vessel wall 60 can comprise a material that has a Shore A hardness greater than that of the region of surface irregularities 150 to provide for a rigid vessel wall that is stiff when the consumer grips the dosing cap 10 to remove the dosing cap 10 from the container 110, is stiff enough to withstand installation with the container 110 during production of consumer product, and is stiff enough to withstand shipping and storage.

The base exterior 40 has a base exterior surface area, which is the area of the surface of the base exterior 40. To provide for a dosing cap 10 having a large enough region of surface irregularities 150 to be visible to the observer 17 at shelf and effective for pretreating stains, the region of surface irregularities can comprise between about 10% to about 90% of the bases exterior surface area. The region of surface irregularities 150 can comprise more than about 15% of the base exterior surface area. The region of surface irregularities 150 can comprise more than about 25% of the base exterior surface area. The region of surface irregularities 150 can comprise more than about 35% of the base exterior surface area. The region of surface irregularities 150 can comprise more than about 45% of the base exterior surface area. By having such arrangement, the consumer might be able to better identify that the region of surface irregularities 150 has some unique property and/or capability as compared to other regions or portions of the base exterior 40 because the region of surface irregularities 150 contrasts visually with the remainder of the base 20 of the cap.

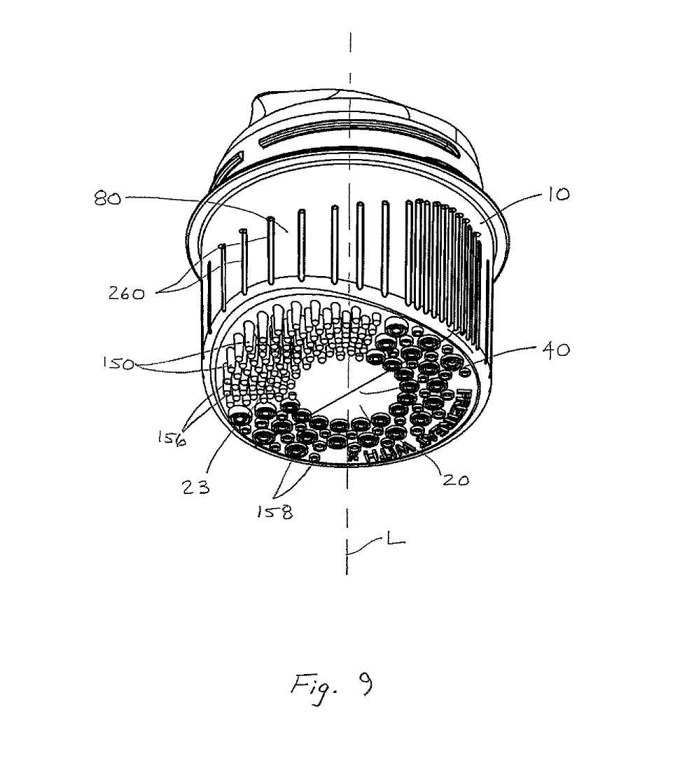

FIG. 9 is a perspective drawing of a dosing cap 10. When the dosing cap 10 is viewed in profile, the surface irregularities 150, which are shown in this example as bristles 156, can be visible to a consumer having her eye level with the base exterior surface 40. The dosing cap 10 shown in FIG. 9, or other such dosing cap, whether the dosing cap 10 is a closure or some other component attached to the container 110 in some manner, can be practical for any of the embodiments disclosed herein. A second region of surface irregularities 150 can also be provided on the base exterior surface 40 of the dosing cap, such as in FIG. 9, rings 158.

All percentages and ratios used herein are by weight of the total composition and all measurements made are at 25° C., unless otherwise designated. An angular degree is a planar unit of angular measure equal in magnitude to 1/360 of a complete revolution.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited are, in relevant part, incorporated herein by reference; the citation of any document is not to be construed as an admission that it is prior art with respect to the present invention.

What is claimed is:

1. A laundry detergent package comprising:
a container having a container interior surface and an opposing container exterior surface, wherein said container exterior surface has a primary label face; and
a dosing cap comprising a base and a vessel wall extending from said base, said base having a base interior surface and an opposing base exterior surface, said vessel wall having a vessel wall interior surface and an opposing vessel wall exterior surface,
wherein said base exterior surface comprises a region of surface irregularities;
wherein said dosing cap is releasably engaged with said container;
wherein said region of surface irregularities is positioned such that when said primary label face is aligned with a line of sight of an observer having her eye level with said base exterior surface said region of surface irregularities is visible to said observer.

2. The laundry detergent package of claim 1, wherein said vessel exterior surface comprises a plurality of gripping irregularities selected from the group consisting of depressed portions relative to said vessel wall, raised portions relative to said vessel wall, and combinations thereof.

3. The laundry detergent package of claim 1, wherein said region of surface irregularities has a centroid in a plane orthogonal to a longitudinal axis of said dosing cap, wherein said centroid is more than about π/8 radians away from said line of sight as measured about said longitudinal axis of said dosing cap.

4. The laundry detergent package of claim 3, wherein said centroid is about π/2 radians away from said line of sight as measured about said longitudinal axis of said dosing cap.

5. The laundry detergent package of claim 1, wherein said region of surface irregularities are structures selected from the group consisting of rings, ribs, nubs, bristles, fibers, and combinations thereof.

6. The laundry detergent package of claim 1, wherein said region of surface irregularities comprises a first material and said vessel wall comprises a second material, wherein said first material and said second material differ from one another in chemical composition.

7. The laundry detergent package of claim 1, wherein said region of surface irregularities comprises a first material and said vessel wall comprises a second material, wherein said first material and said second material are measured by a Hunter Reflectance Meter test according to the colors L*, a*, and b*, the L*, a*, and b*, wherein said first material has a color difference, the color difference being calculated using the L*, a*, and b* values by the formula ΔE=[(L*_{X}*−L*_{Y})²+(a*_{X}*−a*_{Y})²+(b*_{X}−b*_{Y}²]^{1/2}, wherein said ΔE between said first material and said second material is at least about 1.

8. The laundry package of claim 1, wherein said region of surface irregularities comprises bristles.

9. The laundry package of claim 1, wherein said container has a handle integral with or extending from said container, wherein said region of surface irregularities has a centroid, wherein said handle and said centroid are substantially aligned on a common side of said package or wherein said handle and said centroid are on opposing sides of said package.

10. A plurality of laundry packages, each laundry package according to claim 1, wherein each said dosing cap has a longitudinal axis and said plurality of laundry packages is arranged such that said longitudinal axis of each respective dosing cap is substantially aligned within a common line of alignment.

11. A plurality of laundry packages according to claim 10, wherein each respective region of surface irregularities has a centroid in a plane orthogonal to a longitudinal axis of each respective dosing cap, wherein each respective centroid is more than about π/8 radians away from said line of sight as measured about said longitudinal axis of each respective dosing cap.

12. A plurality of laundry packages according to claim 10, wherein each respective region of surface irregularities has a centroid in a plane orthogonal to a longitudinal axis of each respective dosing cap, wherein each said centroid is positioned about zero radians away from said common line of alignment as measured about each respective longitudinal axis.

13. A plurality of laundry packages according to claim 10, wherein each respective region of surface irregularities is a structure selected from the group consisting of rings, ribs, nubs, bristles, fibers, and combinations thereof.

14. A plurality of laundry packages according to claim 10, wherein each respective region of surface irregularities comprises a first material and said vessel wall comprises a second material, wherein said first material and said second material differ from one another in chemical composition.

15. A plurality of laundry packages according to claim 10, wherein each respective region of surface irregularities comprises a first material and said vessel wall comprises a second material, wherein said first material and said second material are measured by a Hunter Reflectance Meter test according to the colors L*, a*, and b*, the L*, a*, and b*, wherein said first material has a color difference, the color difference being calculated using the L*, a*, and b* values by the formula ΔE=[(L*_{X}*−L*_{Y})²+(a*_{X}*−a*_{Y})²+(b*_{X}−b*_{Y})²]^{1/2}, wherein said ΔE between said first material and said second material is at least about 1.

16. A plurality of laundry packages according to claim 10, wherein each respective region of surface irregularities comprises bristles.

17. The laundry package of claim 1, wherein said label face has a brand logo, said brand logo being larger than any other appearance of said brand logo on another portion of said container.

18. A plurality of laundry packages according to claim 10, wherein each respective region of surface irregularities has a centroid in a plane orthogonal to a longitudinal axis of each respective dosing cap, wherein each said centroid is positioned within no more than about 0.125 radians away from said common line of alignment as measured about each respective longitudinal axis.

19. The laundry package of claim 1, wherein said dosing cap is releasably engaged with an opening in said container such that said base interior surface, said vessel wall interior surface, and said container interior surface together define an enclosure containing a laundry detergent.
